(19) United States
(12) Patent Application Publication
(10) Pub. No.: US 2017/0282632 A1
(43) Pub. Date: Oct. 5, 2017

(54) Combination Journal

(71) Applicant: Kathleen Neville, Birmingham, MI (US)

(72) Inventor: Kathleen Neville, Birmingham, MI (US)

(21) Appl. No.: 15/090,568

(22) Filed: Apr. 4, 2016

(51) Int. Cl. B42F 13/40; B42D 1/08; B42D 1/10; B42D 1/00; B42F 3/00

(52) U.S. Cl. CPC B42F 13/40; B42D 1/004; B42F 3/006; B42D 1/10; B42D 1/08

(57) ABSTRACT

A system and method for a journal. The system includes a journal which has a cover coupled to a binder. The binder is coupled to a plurality of journal pages, and at least one of the journal pages has at least one entry. The system further includes a printer for printing a photograph and a printer page for loading into the printer. A photograph can be taken with a device such as a camera or smart phone. Thereafter, the photograph is sent to the printer. The photograph can be detached from the printer page and adhered to one of the entries on the journal pages.

### BACKGROUND OF THE INVENTION

### Technical Field

The present invention relates to a system and method for using a journal.

### Description of Related Art

Many consumers use a physical day planner to document future events such as meetings or lunches. Further, many consumers like to document and keep track of events from the past. Many use scrapbooking, journaling, or the like, to document and remember past events. Consequently, there is a need for a combination day planner and journal which allows future and past events to be captured.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a top view of a journal in one embodiment;

FIG. 2 is a top view of an open journal in one embodiment;

FIG. 3 is a top view of a page in one embodiment;

FIG. 4 is a top view of a printer in one embodiment;

FIG. 5 is a top view of a system in one embodiment;

FIG. 6 is a top view of a printer page in one embodiment.

### DETAILED DESCRIPTION

Several embodiments of Applicant's invention will now be described with reference to the drawings. Unless otherwise noted, like elements will be identified by identical numbers throughout all figures. The invention illustratively disclosed herein suitably may be practiced in the absence of any element which is not specifically disclosed herein.

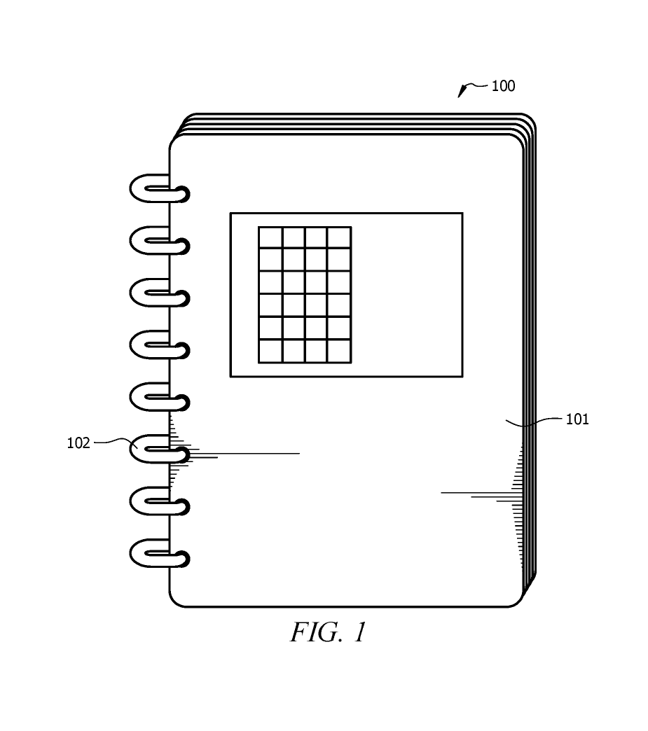

FIG. 1 is a top view of a journal in one embodiment. In one embodiment a journal comprises a day planner, journal, scrapbook, record-keeping system, and/or diary. In one embodiment the journal comprises a combination of these features. For example, in one embodiment the journal comprises a combination day planner and scrap book. The journal, in some embodiments has time increments such as hours, days, weeks, months, etc. whereby users can schedule and document their day, week, month, and year. In other embodiments, however, the journal does not comprise such time increments. In one such embodiment, the journal simply comprises blank pages which are not tied or limited to a day, week, month, or year. In other embodiments the journal comprises a hybrid of the above variations which features blank pages as well as pages which comprise time increments.

While many users rely upon a day planner to organize their day, month, and year, many users want to do more with their journals. For instance, if a lunch is planned, after the lunch, the user may want to remember the lunch with a picture from the lunch. While the user may take a picture of the lunch, the picture is often stored on a smart phone in an unorganized manner. Accordingly, in one embodiment discussed herein, a journal system and method is discussed wherein a user can combine their day planner with their love of scrap booking and journaling in a fast and efficient way.

As depicted in FIG. 1, the journal 100 has a cover 101 and a binder 102. The cover 101 can comprise any cover 101 known in the art. In one embodiment the cover 101 is sturdy and/or water proof or water resistant.

The binder 102, as used herein, refers to an object which couples the various pages and cover 101 together. The binder 102 can comprise any coupling device or method known in the art. The binder 102 can include spiraling, a traditional 3-hole punch notebook, an adhesive such as a glue, friction binding, an arch binding system, a 3-8 hole punch, magnetic, lid, plastic comb, wire-o, double-loop, twin-loop, vela, tape, fast, saddle stitched, lay-flat, screw and post, etc. In one embodiment the binder 102 comprise a closed binder whereby additional pages cannot be added or removed. A spiral notebook is an example of a closed binder.

In other embodiments, however, the binder 102 comprises an open binder. An open binder is one where journal pages can be added or removed. An open binder has the extra benefit of allowing additional pages to be added or removed, as well as the increased flexibility of providing pages with various formatting, sizes, etc., as discussed below.

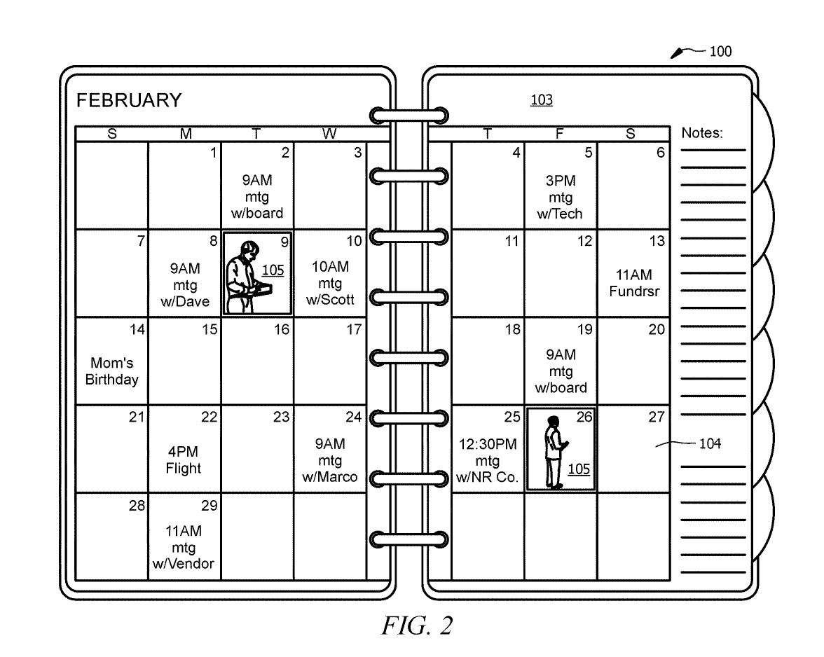

In one embodiment the binder 102 comprises the Arc System by Staples®. The Arc system uses a series of arcs which can be opened and closed as needed. As such, the Arc system is an open binder 102. FIG. 2 is a top view of an open journal in one embodiment. As can be seen, the journal has a plurality of pages 103. The pages 103 can have virtually any orientation and layout. As depicted, a pair of open pages are used to show the month of February. As shown, the weeks are oriented horizontally such that each week is in a single horizontal row. Each day, for example, a Tuesday, is oriented in a single vertical column. This layout is for illustrative purposes only. In other embodiments, for example, a pair of open pages is used to show a single week. In still other embodiments, a single page is used to depict a single week. In one embodiment the page layout is consistent throughout meaning that, for example, a pair of open pages consistently shows a single month. In other embodiment the page layout is inconsistent. For example, for some months a pair of open pages will show a single month whereas in other pages a pair of open pages will show a week. This flexibility allows the user to customize their journal. For example, if the user is on vacation, of has a particularly busy week, that user may want to document that week in more detail than other weeks. This flexibility allows the user to customize their journal by providing the ability to add additional space and/or pages when needed by adjusting the layout. As noted above, in some embodiments the journal pages 103 does not depict a time increment.

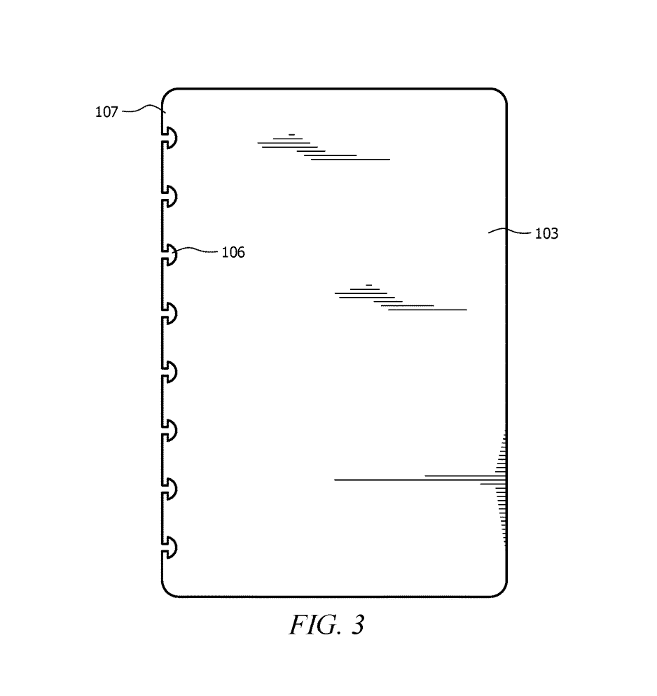

Turning momentarily to FIG. 3, FIG. 3 is a top view of a page 103 in one embodiment. The journal page 103 comprises at least page coupler 106 located on the left side. As depicted, and in some embodiments, the page 103 comprises a plurality of page couplers 106. A page coupler 106 is a hole, voice, loop, etc. which allows the page 103 to be coupled, either permanently or releasably, to the binders 102.

The page couplers 106 can comprise virtually any size, shape, number, and orientation.

In one embodiment the journal page 103 comprises a tear resistor 107. A tear resistor 107, as used herein, refers to any material or processing technique which strengthens the page couplers 106 and makes them resistant to tearing. The tear resistor 107 can comprise a material, such as a tape, adhesive, lamination, or coating along at least a portion of the page couplers 106 which strengthens the page couplers 106. The tear resistor 107 offers protection against a page 103 becoming accidentally torn when reading or flipping the pages. The tear resistor 107 accordingly increases the life of the journal.

In one embodiment the tear resistor 107 and/or the page couplers 106 comprise an anti-friction agent which reduces the friction with the binder 102. An anti-friction agent allows the page 103 to more smoothly turn and move relative to the binder 102 and prevents wear and tear as the page 103 is repeatedly turned.

It should be noted that while the figures, and FIG. 3 specifically, depict the page couplers 106 being located on a side edge, this is for illustrative purposes and should not be deemed limiting. In other embodiments the page couplers 106 are located on a top or bottom edge. In such embodiments the pages would be coupled along the top or bottom.

Turning back to FIG. 2, each journal page 103 comprises at least one entry 104 where text, pictures, notes, information, scraps, etc. can be inserted. An entry 104 is a location on the journal page 103 where an item, such as text, pictures, notes, information, scraps, etc. can be entered or inserted. In the layout depicted, each day comprises one entry 104. As noted, however, this is for illustrative purposes only and should not be deemed limiting. In other embodiments the entry can comprise an hour, a week, a morning, or virtually any period of time. In such embodiments, the entry 104 is tied to a time increment. In still other embodiments, however, the entry 104 is not tied to a time increment. In one embodiment, the entry 104 comprises blank space on a page.

An entry is where a record, either future or past, is recorded. For example, an appointment for lunch can be recorded in an entry 104 which has yet to occur. The entry 104 can also comprise a memory, photograph, sketch, etc. of things events which have already occurred. Virtually any writing, photo, image, hyperlink, etc. can be stored in an entry 104.

In one embodiment the user is provided the opportunity to customize one or more entries before the customer receives the journal. Thus, for example, a user can input their anniversary, birthdays, known events such as a graduation or wedding, and these dates and events will be pre-printed onto the page. This provides the opportunity to pre-load one or more entries into the journal.

As noted, while FIG. 2 depicts a layout where the majority of available space is occupied by entries 104, this is for illustrative purposes only and should not be deemed limiting. In one embodiment users are allowed to customize the layout to fit their desired orientation. As but one non-limiting example, a pair of open pages will represent a week, and ample white space, not in the form of an entry, is provided to allow for the addition of photographs and other scrapbooking items.

As depicted in FIG. 2, a photograph 105 has been placed in one entry 104. As noted above, in some embodiments a photograph 105 is added to an entry but the photograph 105 can be added at virtually any location of the user's choosing. One embodiment wherein the photograph 105 is placed in an entry 104 will be discussed for illustrative purposes.

A photograph, as used herein, refers to any picture recorded on an item. The photograph 105 can be directly printed on the page 103, or it can be separated printed and adhered to the page 103.

A photograph 105 allows a memory to be captured and stored. As noted, with the popularity of cameras on smart phones, as well as the small and convenient size of cameras, people are taking a lot of pictures. Unfortunately, while the users have the pictures, there is no way to couple the pictures with a journal in an organized manner. The system and method discussed herein, in one embodiment, allows the user to schedule a future lunch, attend the lunch, and document a memory of the lunch by putting a photograph from the lunch in the journal. In this way, as discussed in more detail below, at the end of the year the user will have a journal which once served as an organizer for the future, now serve as an organizer of the past. The journal will serve as a collector of memories which can be shared and remembered in an organized manner.

As noted, in one embodiment the photograph 105 can be directly printed on the page 103. In such an embodiment, the user removes the page 103, places the page 103 in a printer, and the printer prints the photograph in the desired location.

In another embodiment, however, the photograph is separately printed or prepared and thereafter attached to the page 103. One method and system will be described in reference to a printer. This is for illustrative purposes only and should not be deemed limiting.

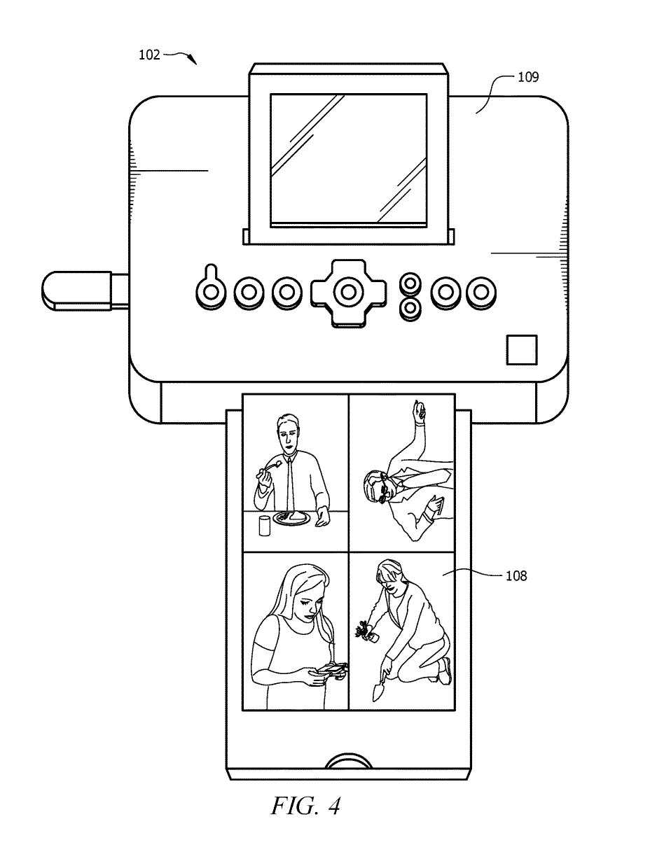

In one embodiment, a photograph 105 is first captured. The photograph can be captured with a camera, smart phone, etc. One embodiment will be discussed in reference to a smart phone. Once the photograph has been captured, the photograph is sent to a printer. Turning to FIG. 4, FIG. 4 is a top view of a printer 109 in one embodiment. FIG. 4 shows four photographs 105 being printed on the printer page 108.

Virtually any printer of any printer type can be utilized. These include ink printers, laser printers, etc. A printer is any object which prints a photograph on a tangible medium, such as paper, metal, foil, film, plastic, Zink, etc. Accordingly, printers can include traditional printers as described above, as well as cameras which immediately produce a photograph on film, such as a Polaroid®. In one embodiment the printer comprises a pocket printer. The pocket printer is any printer which has dimensions such that it can be easily carried by a user in one hand. In one embodiment the printer has dimensions of less than 10 inches long by less than 10 inches wide and less than 5 inches thick. In one embodiment the pocket printer comprises a Polaroid Zip printer which has approximate dimensions of 4.7 inches by 2.9 inches by 0.9 inches. Another example of a pocket printer is the LG Pocket Photo Printer (PD233/PD251) which has dimensions of about 4.5 inches by 3 inches by about 1 inch. Another example is the LG Pocket Photo Printer (PD241T) which has dimensions of about 5.9 inches by 4.5 inches by 2.3 inches. Another example is the Dell Wasabi Mobile Thermal Printer (PZ310) with dimensions of about 4.8 inches by 2.9 inches by 0.9 inches. Another example includes the Fugi Film Insta Share with dimensions of about 8 inches by 4.1 inches by 1.6 inches.

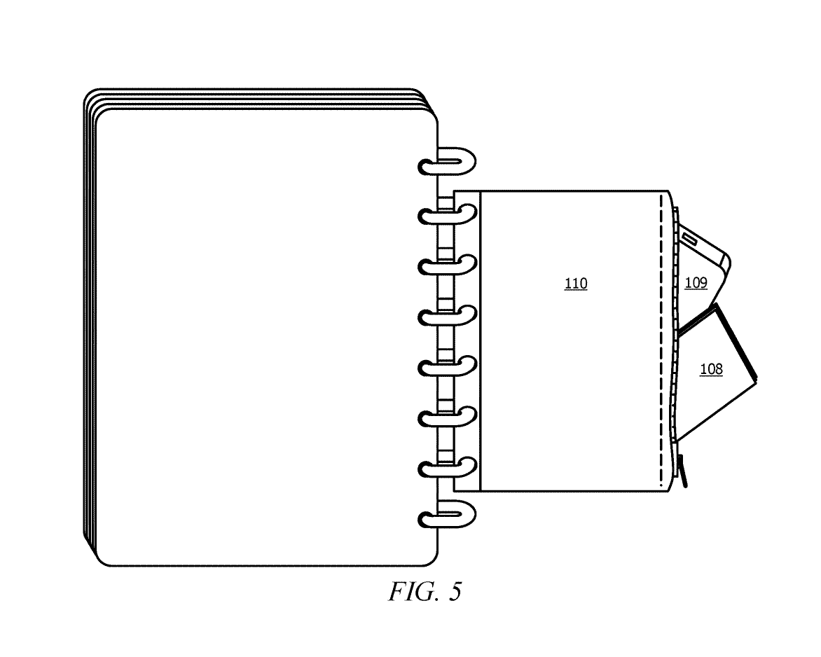

FIG. 5 is a top view of a printer coupled to the journal in one embodiment. In one embodiment the journal is coupled to a printer holder 110. As depicted, the printer holder 110 is coupled via the binder 102, but the printer holder 110 can be coupled to the journal at any location. In one embodiment, the printer holder 110 comprises the printer 109 and a printer page 108. While a printer holder 110 is disclosed in one embodiment, in other embodiments there is no holder 110 and the printer is housed and/or coupled to the journal. The printer 109 can be housed, for example, in a pocket or envelope within the journal, attached to the journal, or otherwise coupled to the binder.

Having the printer 109 readily accessible increases the likelihood that the printer 109 will be used. Further, having the printer 109 readily accessible increases efficiency as the user has access to the printer 109 at virtually any time.

The photograph can be transferred to the printer 109 for printing via virtually any method or device known in the art. This includes, but is not limited to, a hard wire, a wireless connection, a Blue-tooth connection, etc. This allows the device, such as a smart phone or a camera, to send the photograph 105 to the printer 109 for printing. The printer 109 can be powered via hard wiring or via a battery.

While one method has been described wherein the photograph is printed, in other embodiments the photograph is not printed. Instead, a link, hyperlink, QR-code, bar code, etc. is printed and thereafter adhered to the journal. In this manner, a user must scan the hyperlink to view the photograph.

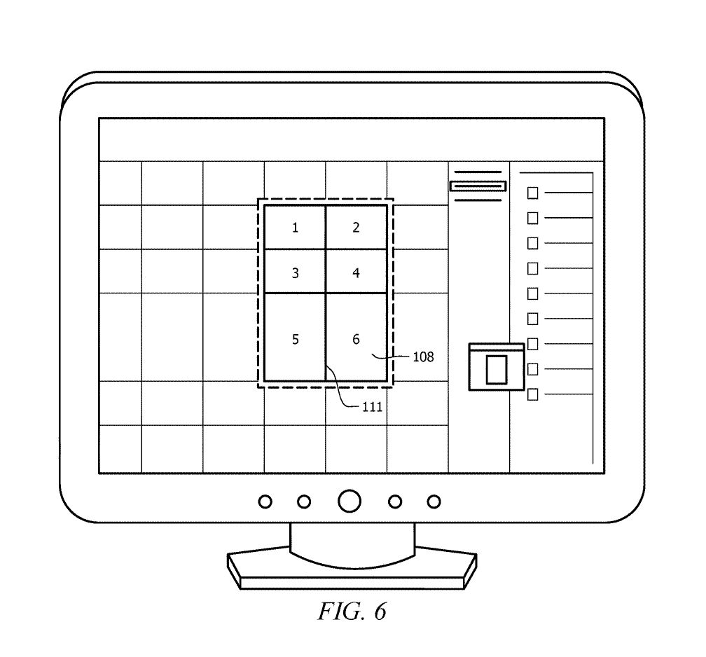

Turning now to FIG. 6, FIG. 6 is a top view of a printer page in one embodiment depicted on a computer screen. The printer page 108, as depicted, has six separate print areas, though virtually any number of print areas can be utilized. The print areas are the areas which will be printed with the photograph 105. Thus, as depicted in FIG. 6, six separate photographs can be printed with this printer page 108. The size and layout of the printer page 108 can be adjusted as necessary as desired by the user. In one embodiment the size and layout of the printer page 108 is adjusted to match or conform to the size of the entry 104 on the journal page 103. As depicted, the printer page 108 is shown on a computer screen so that the user can select the size, orientation, etc. of the photograph. This is where the user can determine if the photograph should occupy a single entry or multiple entries.

In one embodiment, software located on the phone or camera, for example, is used to determine the appropriate size for the photograph. The software will recognize which journal the user is using, and provide the user with options as to the size. The user can limit the size of the photograph to a single entry 104, or the user can allow the photograph to occupy the space of two or more entries 104. Further, as noted, the user can opt to place the photograph 105 outside of an entry 104.

In one embodiment a single photograph is printed in the print area. In such embodiments, the same printer page 108 can be reused multiple times to obtain subsequent photographs. In other embodiments, however, multiple photographs for different entries 104 are printed in a single printer page 108.

As depicted, and in one embodiment, the printer page 108 comprises a line of weakness 111. A line of weakness 111, as used herein, refers to a score, perforation, tear, or other such line of weakened connection which allows a tear to propagate along a desired direction. A line of weakness 111 allows a single photograph to be removed and separated from the printer page 108. As noted, the line of weakness 111 can comprise scoring, perforations, etching, etc. which allow a photograph to be separated from the printer page 108 without tearing either the photograph or the printer page 108.

In one embodiment a blank printer page 108 comprises one or more lines of weakness 111. Thus, when the printer page 108 is inserted into the printer 109, the printer page 108 already comprises one or more lines of weakness 111.

After the photograph has been captured by a device, the device sends the photograph to the printer 109. Thereafter, a printer page 108 is inserted into a printer 109, and the printer 109 prints the page 108 which comprises at least one photograph 105. Now, the single photograph 105 is separated from the printer page 108. In one embodiment, the photograph 105 is separated from the printer page 108 via the line of weakness 111.

After the photograph 105 has been removed, it is now adhered to the journal page 103 in the desired location. The photograph 105 can be adhered via any method or device known in the art for adhering a photograph to a sheet of paper including adhesive, glue, tape, etc. The term adhesive, as used herein, refers to the large umbrella of compounds, glue, tape, etc. which can adhere two objects together. In one embodiment the printer page 108 comprises a peel and stick backing. In such an embodiment the back of the printer page 108 comprises a backing which, when removed, exposes a layer of adhesive. Thus, upon removing the backing, the photograph 105 can be adhered to the journal page 103.

In another embodiment the back of the printer page 108 comprises an adhesive which must be activated via moisture, similar to a stamp. In such embodiments the photograph 105 need simply be licked or wetted before adhering the photograph 105 to the page 103. In still other embodiments the printer page 108 comprises a pressure sensitive adhesive which is not activated until pressure is applied.

As can be seen, in some embodiments the printer page 108 comprises adhesive or the like on the backside of the printer page 108. Accordingly, in one embodiment the printer page 108 comprises at least one line of weakness 111 and an adhesive on the back of the printer page 108. Such an embodiment has advantages in that once the photograph is printed, it can be separated and easily adhered to the journal page 103. This method has fewer steps, requires fewer devices, and results in increased efficiency.

In still other embodiments, the printer page 108 does not comprise adhesive; rather, adhesive must be added to the photograph 105. In one such embodiment a stickering device is used. A stickering device is a device which applies an adhesive to the back surface of an object so the object can be adhered to another surface. The stickering device, in one embodiment, applies an adhesive to the back of the photograph 105, which can then be adhered to the journal page 103. One example of a stickering device includes the Xyron Create a Sticker by Xryon Inc. out of Scottsdale Ariz.

While one embodiment wherein photographs 105 are adhered to the planner page 103, this is for illustrative purposes only and should not be deemed limiting. Stickers, tickets, and other items used in scrapbooking can also be added to the pages 103. In one embodiment stickers with bar codes, such as QR codes, can be added to the pages 103 which, when scanned, can depict a picture, video, etc. This provides another opportunity to capture a memory.

As discussed, in one embodiment a journal system is disclosed wherein the system comprises a journal comprising a cover and a plurality of pages bound by a binder. The system, in some embodiments, is further coupled to a pocket printer which has at least one print page. In one embodiment the print page comprises at least one line of weakness which allows a printed photograph to be separated from the print page. In still another embodiment the print page comprises adhesive on the back such that the photograph can be adhered to the journal page.

While the system has been described, one embodiment of utilizing the method of journaling in a journal system will now be described. In one embodiment the journal system comprises a plurality of journal pages coupled to a binder, wherein at least one of the journal pages comprise at least one entry. The system further includes a printer, such as a pocket printer discussed above, for printing a photograph, as well as a printer page which comprises at least one line of weakness. In one embodiment, the first step comprises taking a photograph with a device. As noted, the device can comprise a smart phone, a camera, etc. Next, the photograph is send to the printer where it is printed. The photograph is then removed. In one embodiment the photograph is detached from the print page via the line of weakness. In such embodiments, external cutting or separating devices, such as scissors, are not necessary. This is a benefit as it reduces the number of tools required. Next, the photograph is adhered to at least one of the entries using the methods discussed herein.

The above described system and method has several benefits over the prior art. First, the system, in one embodiment, has all the necessary materials and tools to print a photograph and adhere it to a journal. Absent this system and method, the user would be required to capture a photograph, sit before a desktop connected to a printer, print the photograph, cut the photograph, and apply adhesive to the photograph so that it could be adhered to the journal. These steps and tools required that the user set aside blocks of time where all the tools necessary were available. Scrap-booking and journaling, such as described above, are time consuming activities. When a user becomes busy, the user will fall behind on the journaling. However, with the system and method described above, the user can print photographs virtually anywhere. If the user photographs a memory at lunch, the user can print the photograph and adhere it to the journal while waiting for the check. Captured events can easily and quickly be documented. Without the easy of this documentation, many memories will not be properly recorded.

Another benefit is the reduction of unnecessary steps. As noted, because in some embodiments the printer page 108 comprises a line of weakness 111, the need for scissors or a separate cutting step is eliminated. Likewise, in embodiments wherein the printer page 108 comprises adhesive, the need to separately provide an adhesive is eliminated Eliminating these steps, as well as the associated tools, makes it more efficient for a user to capture and record a memory in the journal.

Another benefit is the ability to combine day planning, scrap booking, and journaling within a single album. Previously day planning was limited to scheduling future events whereas journaling was limited to documenting past events. The system and method discussed herein show that scrap-booking, journaling, and day planning can be combined in a single activity. The resulting journal has a list of the events which occurred throughout the year as well as photographs documenting those memories. The journal will serve as a reminder of all the events, photographs, and memories made in a single year. The next year can start fresh with a new journal. Thus, rather than a typical journal containing only appointments which will be thrown away at the end of the year, the journal disclosed herein will be a journal for the previous year. An additional benefit is the ability to organize the user's life as well as remove digital photos from a user's phone, camera, etc. and place real and physical pictures into the real world where they can be viewed, appreciated, etc. Additionally, a benefit is the ability to save the user's daily thoughts and memories right on the spot and when they happen. This allows the user to use their time more efficiently while expressing their own unique style and preferences.

The journal can be sent to friends and family to add their books. Further, users may have different journals for all aspects of their life. For example, a user can have a pregnancy book to document their child's development and milestones as they occur. Further, a user can have a wedding planner book to keep track of all of the different aspects of planning their big day. The same can be said for vacation planning, summer camp, etc. Theme parks can sell themed books for guests to record their experience, photos, and memories right on the spot when they occur. As noted, because in some embodiments the system is portable, it can be taken everywhere, further encouraging and enabling the user to record their life and memories. Teens and college students can use this system to record their experiences.

As noted, in one embodiment at least one entry of the journal is tied to a time increment. As noted, in one embodiment the journal can span a specified time period such as a month, a year, a pregnancy, etc. In other embodiments, however, the journal is not explicitly tied to a time increment or time interval. Rather, in some embodiments, the journal is tied to a project or a series of projects. For example, the journal can be used to document a project. Consider, for example, a movie production. One of the journal's first entries can be an initial sketch of a character. The artist can either draw the sketch in the entry, or take a picture of the sketch and couple to the picture of the sketch to the journal, provide a link within the journal, etc. Thereafter, the artist can document how that character grows and morphs. The journal can document when the first draft of the script was completed. A hyperlink, QR-code, etc. can be stored in the journal. The same applies to the second and subsequent scripts. Then the artist can document the screenplay, when it was submitted to various producers, their responses, etc. Finally, the artist can document when the movie was made, reviews, box office reports, etc. Such a journal may span several years as opposed to be limited to one year. The resulting journal will chronicle the entire journey, and the artist can flip back to page one and review and remanence over the first thumb sketch which has transformed into a motion picture.

The journal can also chronicle the progression of talent and skill. Consider a beginning artist. One of the first entries can be the artist's first attempt at a painting. As before, the painting can be directly applied to the journal, or the journal can comprise a picture, link, hyperlink, etc. to the first painting. The artist can share their thoughts on the experience and their thoughts on their first attempt. Subsequent pages can show how the artist has progressed, how the style has changed, and how the talent and skill have advanced. In the same manner, the journal can document a novice learning a new instrument, such as a guitar. The journal can include pictures of the first guitar, links to the first recording, pictures of the first lesson, etc. As the student continues to learn, this will be reflected in the journal with further pictures, details, notes, scrapbooks, memories, etc.

While the journal described herein can be used to document and chronicle memories, the journal can also be used as a project management tool. The journal can be utilized with virtually any project and any goal. As an example, consider a weight loss journal. The journal described herein can include beginning weights, and can also include pictures of the user at the beginning weight. The journal can be used to help document the user's various goals along the path. The user can take pictures and share memories when the first 5 pounds were lost. The journal can have the date of the first 5 k race with various metrics and training goals which are tied to the race. The journal can not only include and reference deadlines, but it can show proof, such as photographs, thoughts, memories, etc. of that deadline being met.

Consider a new product development. One journal can track and monitor the progression of the product from the initial idea through production. The journal can include deadlines, such as patent filing deadlines, as well as pictures, links, etc. documenting that the user has met the deadline by filing a patent application, for example. The journal can, for example, include a link to the filed patent application, a picture of the filing receipt, etc. In this fashion, the user of the journal can set deadlines, as well as document the progression of the project. In this manner, when the production manager, for example, wants to know who the user met with when selecting the materials, the journal can include the name, a picture, and notes relating to the user's meeting with the materials engineer. Accordingly, the journal can include all relevant information relating to the management and progression of a project. The journal can be both forward looking such as keeping the user on task and the project on schedule, as well as backward looking serving as a record-keeping system which documents and chronicles the details of a project.

While the invention has been particularly shown and described with reference to a preferred embodiment, it will be understood by those skilled in the art that various changes in form and detail may be made therein without departing from the spirit and scope of the invention.

### Additional Description

The following clauses are offered as further description of the disclosed invention.
Clause 1. A system for a journal, said system comprising:

a cover coupled to a binder;

a plurality of journal pages coupled to said binder;

wherein at least one of said journal pages comprises at least one entry;

a printer for printing a photograph;

a printer page.
Clause 2. The system of any proceeding or preceding clause wherein said printer is coupled to said binder, and wherein said printer comprises a pocket printer.
Clause 3. The system of any proceeding or preceding clause wherein said printer is housed in a printer holder, and wherein said printer holder is coupled to said binder.
Clause 4. The system of any proceeding or preceding clause wherein said printer page comprises at least one line of weakness.
Clause 5. The system of any proceeding or preceding clause wherein said printer page comprises a backing which comprises an adhesive.
Clause 6. The system of any proceeding or preceding clause wherein said printer page comprises a photograph on a front side and an adhesive backing on a back side.
Clause 7. The system of any proceeding or preceding clause wherein at least one of said journal pages comprises at least one photograph adhered to one entry.
Clause 8. The system of any proceeding or preceding clause further comprising a stickering device which adds an adhesive to said printer page.
Clause 9. The system of any proceeding or preceding clause further comprising a mobile device for communication with said printer, wherein said mobile device comprises an application which allows the user to select the size of the photograph on the printer page.
Clause 10. The system of any proceeding or preceding clause wherein said binder comprises an open binder, and wherein at least one of said plurality of journal pages comprises a tear resistor.
Clause 11. A method of journaling in a journal system, wherein said journal system comprises:

a plurality of journal pages coupled to a binder;

wherein at least one of said journal pages comprises at least one entry;

a printer for printing a photograph;

a printer page, wherein said printer page comprises at least one line of weakness;

wherein said method comprises:
a) taking a photograph with a device;
b) sending said photograph to said printer;
c) printing at least one photograph;
d) adhering said photograph into of said entries.
Clause 12. The method of any proceeding or preceding clause further comprising the step of removing said photograph from said printer page along said line of weakness.
Clause 13. The method of any proceeding or preceding clause wherein said removing step does not require scissors.
Clause 14. The method of any proceeding or preceding clause wherein said adhering of step d) comprises removing a backing and applying said photograph to one of said journal pages.
Clause 15. The method of any proceeding or preceding claim wherein said printer comprises a pocket printer.
Clause 16. The method of any proceeding or preceding clause wherein said pocket printer is housed in a printer holder, and wherein said printer holder is coupled to said binder
Clause 17. The method of any proceeding or preceding clause wherein said adhering comprises sending said photograph through a stickering device.
Clause 18. The method of claim 11 wherein said taking comprises taking a photograph with a smart phone, and wherein said sending comprises sending a digital photograph wirelessly.
Clause 19. The method of claim 11 wherein said printing comprises selecting a photograph dimension which matches the dimensions of at least one of said entry.

What is claimed is:

1. A system for a journal, said system comprising:
a cover coupled to a binder;
a plurality of journal pages coupled to said binder;
wherein at least one of said journal pages comprises at least one entry;
a printer for printing a photograph;
a printer page.

2. The system of claim 1 wherein said printer is coupled to said binder, and wherein said printer comprises a pocket printer.

3. The system of claim 2 wherein said printer is housed in a printer holder, and wherein said printer holder is coupled to said binder.

4. The system of claim 1 wherein said printer page comprises at least one line of weakness.

5. The system of claim 4 wherein said printer page comprises a backing which comprises an adhesive.

6. The system of claim 4 wherein said printer page comprises a photograph on a front side and an adhesive backing on a back side.

7. The system of claim 1 wherein at least one of said journal pages comprises at least one photograph adhered to one entry.

8. The system of claim 1 further comprising a stickering device which adds an adhesive to said printer page.

9. The system of claim 1 further comprising a mobile device for communication with said printer, wherein said mobile device comprises an application which allows the user to select the size of the photograph on the printer page.

10. The system of claim 1 wherein said binder comprises an open binder, and wherein at least one of said plurality of journal pages comprises a tear resistor.

11. A method of journaling in a journal system, wherein said journal system comprises:
a plurality of journal pages coupled to a binder;
wherein at least one of said journal pages comprises at least one entry;
a printer for printing a photograph;
a printer page, wherein said printer page comprises at least one line of weakness;
wherein said method comprises:
a) taking a photograph with a device;
b) sending said photograph to said printer;
c) printing at least one photograph;
d) adhering said photograph into of said entries.

12. The method of claim 11 further comprising the step of removing said photograph from said printer page along said line of weakness.

13. The method of claim 12 wherein said removing step does not require scissors.

14. The method of claim 11 wherein said adhering of step d) comprises removing a backing and applying said photograph to one of said journal pages.

15. The method of claim 11 wherein said printer comprises a pocket printer.

16. The method of claim 15 wherein said pocket printer is housed in a printer holder, and wherein said printer holder is coupled to said binder

17. The method of claim 11 wherein said adhering comprises sending said photograph through a stickering device.

18. The method of claim 11 wherein said taking comprises taking a photograph with a smart phone, and wherein said sending comprises sending a digital photograph wirelessly.

19. The method of claim 11 wherein said printing comprises selecting a photograph dimension which matches the dimensions of at least one of said entry.
